(19) United States
(12) Patent Application Publication
(10) Pub. No.: US 2018/0073521 A1
(43) Pub. Date: Mar. 15, 2018

(54) COMPRESSOR DRIVING MOTOR AND COOLING METHOD FOR SAME

(71) Applicant: MITSUBISHI HEAVY INDUSTRIES THERMAL SYSTEMS, LTD., Tokyo (JP)

(72) Inventors: Naoki KOBAYASHI, Tokyo (JP); Kenji UEDA, Tokyo (JP); Yasushi HASEGAWA, Tokyo (JP); Noriyuki MATSUKURA, Tokyo (JP); Shintaro OMURA, Tokyo (JP)

(73) Assignee: MITSUBISHI HEAVY INDUSTRIES THERMAL SYSTEMS, LTD., Tokyo (JP)

(21) Appl. No.: 15/559,169

(22) PCT Filed: Mar. 3, 2016
(86) PCT No.: PCT/JP2016/001152

§ 371 Date: Sep. 18, 2017

(30) Foreign Application Priority Data
Mar. 19, 2015 (JP) 2015-055552

(51) Int. Cl. F04D 29/58; F04D 25/06; F04D 29/42; F04D 29/28; F25B 13/00; F25B 31/00; H02K 9/10

(52) U.S. Cl. CPC F04D 29/5806; F04D 25/06; F04D 29/4206; H02K 9/10; F25B 13/00; F25B 31/006; F04D 29/284

(57) ABSTRACT

A compressor driving motor includes: a rotor; a stator surrounding an outer peripheral part of the rotor; a case accommodating the rotor and the stator; a liquid introduction path introducing a liquid refrigerant from a refrigerant circuit including a compressor; and a gas introduction path introducing a gas refrigerant from the refrigerant circuit. The case includes a downstream chamber located on one end side of the rotor and the stator in an axial direction and provided with the compressor, and an upstream chamber located on the other end side in the axial direction and communicating with the downstream chamber through a gap between the outer peripheral part of the rotor and an inner peripheral part of the stator. The introduced liquid refrigerant and the introduced gas refrigerant are mixed in the upstream chamber, and wet steam of the mixed refrigerant is supplied to at least the gap.

### TECHNICAL FIELD

The present invention relates to a compressor driving motor and a cooling method for the compressor driving motor.

### BACKGROUND ART

There is a method in which a portion of a refrigerant flowing through a refrigerant circuit is supplied to cool a motor that drives a compressor of a refrigerator (for example, Patent Literature 1). In Patent Literature 1, the refrigerant is introduced into a gap between a rotor and a stator to cool the motor.

### CITATION LIST

### Patent Literature

### Patent Literature 1

Japanese Patent Laid-Open No. 2002-138962

### SUMMARY OF INVENTION

### Technical Problem

When heat loss of the motor is increased, an amount of refrigerant necessary for cooling is increased. Using a liquid refrigerant allows for use of latent heat, which makes it possible to efficiently perform cooling; however, an amount of the liquid refrigerant supplied to the gap is desirably small because the liquid refrigerant has large friction resistance.

Therefore, an object of the present invention is to provide a cooling method for a compressor driving motor that makes it possible to perform cooling by supplying a minimum necessary amount of a liquid refrigerant to a gap between a rotor and a stator.

### Solution to Problem

A compressor driving motor according to the present invention includes: a rotor; a stator that surrounds an outer peripheral part of the rotor; a case that accommodates the rotor and the stator; a liquid introduction portion that introduces a liquid refrigerant from a refrigerant circuit including the compressor, into the case; and a gas introduction portion that introduces a gas refrigerant from the refrigerant circuit into the case.

The case includes a downstream chamber and an upstream chamber. The downstream chamber is located on one end side of the rotor and the stator in an axial direction and is located on side on which the compressor is disposed. The upstream chamber is located on the other end side in the axial direction and communicates with the downstream chamber through a gap between the outer peripheral part of the rotor and an inner peripheral part of the stator.

Further, in the present invention, the introduced liquid refrigerant and the introduced gas refrigerant are mixed with each other in the upstream chamber, and wet steam of a mixture of the liquid refrigerant and the gas refrigerant is supplied to at least the gap.

In the present invention, the liquid refrigerant and the gas refrigerant respectively introduced by the liquid introduction portion and the gas introduction portion are mixed with each other in the upstream chamber, and the wet steam of the refrigerant is introduced into the gap between the stator and the rotor along the flow of refrigerating cycle. Therefore, it is possible to sufficiently cool the motor by appropriately setting the respective flow rates of the gas refrigerant and the liquid refrigerant both to be introduced and supplying only a necessary amount of the refrigerant having wetness that conforms to suppression of windage loss.

In the compressor driving motor according to the present invention, the gas introduction portion may preferably introduce the gas refrigerant into a liquid reservoir in which the liquid refrigerant is collected, in the upstream chamber.

As a result, the gas refrigerant is blown into the liquid refrigerant collected in the upstream chamber, which efficiently mix the liquid refrigerant with the gas refrigerant.

In the compressor driving motor according to the present invention, the liquid introduction portion may include a flow path, and suck the liquid refrigerant through a pumping effect and inject the sucked liquid refrigerant. The flow path is provided inside a shaft around which the rotor is coupled, and the pumping effect is caused by centrifugal force acting on the liquid refrigerant flowing through the flow path.

As a result, the liquid refrigerant stably flows through the liquid introduction portion by the centrifugal pumping effect, and is injected from an injection port. The injected liquid refrigerant sufficiently cools a coil end that projects from a stator core into the upstream chamber, and is blown up by the gas refrigerant and flows into the gap.

In the compressor driving motor according to the present invention, the liquid introduction portion may preferably include a first liquid introduction portion and a second liquid introduction portion. The first liquid introduction portion introduces the liquid refrigerant into the upstream chamber without through the flow path inside the shaft, and the second liquid introduction portion includes the flow path inside the shaft and introduces the liquid refrigerant into the upstream chamber through the injection port.

As a result, as described later, it is possible to perform control of using one or both of the first liquid introduction portion and the second liquid introduction portion depending on pressure condition of the refrigerant circuit or the like.

In the compressor driving motor according to the present invention, the case may preferably include a guard portion that receives once the liquid refrigerant injected from the flow path inside the shaft toward a coil end of the stator, and the liquid refrigerant may preferably pass through the guard portion and reach the coil end.

In the compressor driving motor according to the present invention, the downstream chamber may preferably include a guide portion that guides, toward the coil end, the wet steam flowing out from the gap.

The compressor driving motor according to the present invention is suitable to drive a centrifugal compressor including an impeller.

A refrigerant circuit according to the present invention includes the above-described compressor driving motor, a compressor, a condenser, an evaporator, and a decompression section.

Here, it is possible to distribute the gas refrigerant from the discharge side of the compressor in the refrigerant circuit to the gas introduction portion, and to distribute the liquid refrigerant from the downstream side of the condenser in the refrigerant circuit to the liquid introduction portion. This makes it possible to obtain pressure difference to convey the gas refrigerant and the liquid refrigerant to the motor without using external power of a pump or the like.

In addition, according to the present invention, there is provided a cooling method for a motor that includes a rotor, a stator, and a case, and drives a compressor. The stator surrounds an outer peripheral part of the rotor in a radial direction, the case accommodates the rotor and the stator and includes a downstream chamber and an upstream chamber, the downstream chamber is located on one end side of the rotor and the stator in an axial direction and is located on side on which the compressor is disposed, and the upstream chamber is located on the other end side in the axial direction and communicates with the downstream chamber through a gap between the outer peripheral part of the rotor and an inner peripheral part of the stator. The method includes a step of mixing, in the upstream chamber, a liquid refrigerant that is introduced from a refrigerant circuit including the compressor, with a gas refrigerant that is introduced from the refrigerant circuit, and a step of supplying, to at least the gap, wet steam of a mixture of the liquid refrigerant and the gas refrigerant.

### Advantageous Effects of Invention

According to the present invention, the liquid refrigerant flows through the gap while being conveyed with the gas refrigerant. Therefore, it is possible to reliably cool the compressor driving motor by the necessary amount of the refrigerant while reducing windage loss.

### BRIEF DESCRIPTION OF DRAWINGS

FIG. 1 is a schematic diagram illustrating a compressor driving motor according to a first embodiment, and a refrigerant circuit that includes a compressor driven by the motor.

FIG. 2A is a diagram illustrating a necessary amount of a refrigerant with respect to wetness of refrigerant, FIG. 2B is a diagram illustrating windage loss of the motor with respect to the wetness of refrigerant, and FIG. 2C is a diagram illustrating total loss of the motor with respect to the wetness of refrigerant, in which the wetness of refrigerant indicates a rate of liquid, and “1” indicates an entirely liquid phase state.

FIG. 3 is a schematic diagram illustrating a compressor driving motor according to a second embodiment and a refrigerant circuit that includes a compressor driven by the motor.

FIG. 4 is a schematic diagram illustrating a compressor driving motor according to a third embodiment and a refrigerant circuit that includes a compressor driven by the motor.

### DESCRIPTION OF EMBODIMENTS

Some embodiments of the present invention are described below with reference to accompanying drawings.

### First Embodiment

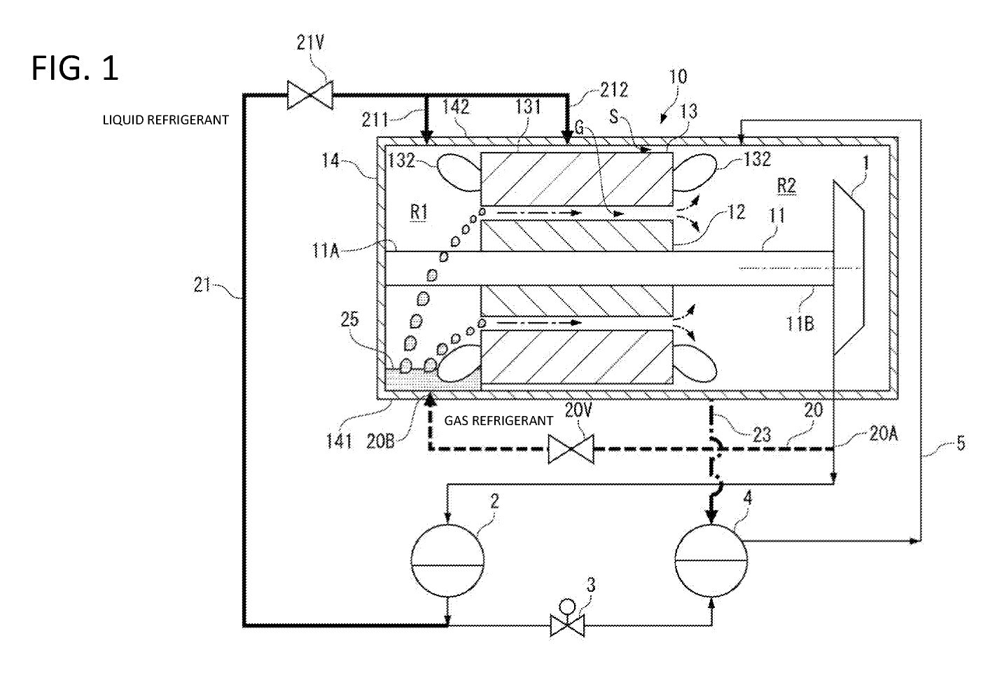

A compressor 1 illustrated in FIG. 1 configures a refrigerant circuit 5, together with a condenser 2, an expansion valve 3, an evaporator 4, and a flow path (illustrated by a thin solid line in FIG. 1) connecting them. The refrigerant circuit 5 is used in a large refrigerator installed in large-scale buildings, facilities, and the like.

The compressor 1 according to the present embodiment is a centrifugal compressor (a turbo compressor) that includes an unillustrated impeller and compress a refrigerant.

A compressor driving motor 10 (hereinafter, referred to as the motor 10) transfers rotational driving force of a shaft 11 to drive the compressor 1.

The motor 10 includes the shaft 11, a rotor 12, a stator 13, and a case 14. The rotor 12 is coupled around the shaft 11. The stator 13 surrounds an outer peripheral part of the rotor 12 in a radial direction. The case 14 accommodates the rotor 12, the stator 13, and the compressor 1. The motor 10 is disposed in posture in which the shaft 11 horizontally extends. An end of a coil (a coil end 132) projects from a core 131 of the stator 13 to each of sides in the axial direction.

The case 14 is a housing common to the motor 10 and the compressor 1. The refrigerant introduced into the case 14 is sucked and compressed by the compressor 1, and the compressed refrigerant is then discharged to a flow path of the refrigerant circuit 5.

The compressed refrigerant discharged from the compressor 1 is sucked into the compressor 1 again through the condenser 2, the expansion valve 3, and the evaporator 4.

When the coil provided in the stator 13 is energized, the rotor 12 rotates with the shaft 11 with respect to the stator 13, which causes the impeller of the compressor 1 to rotate. Rotation of the impeller causes the refrigerant in the case 14 to be sucked into the impeller.

The inside of the case 14 is divided into an upstream chamber R1 and a downstream chamber R2 with the rotor 12 and the stator 13 in between.

In the present embodiment, the refrigerant flows from the upstream chamber R1 toward the downstream chamber R2 in which the compressor 1 is disposed, along flow of the refrigerant in refrigeration cycle.

The upstream chamber R1 is located on rear end 11A side of the shaft 11, and communicates with the downstream chamber R2 through a gap G between the outer peripheral part of the rotor 12 and an inner peripheral part of the stator 13. The gap G is provided over the entire circumference of the rotor 12 and the stator 13.

The downstream chamber R2 is located on front end 11B side of the shaft 11, and the compressor 1 is disposed therein.

The motor 10 generates heat during operation. To ensure operation of the motor 10 and to reduce loss (heat loss) of the motor 10 due to heat generation, it is necessary to sufficiently cool the motor 10.

Therefore, a portion of the refrigerant flowing through the refrigerant circuit 5 is supplied as a motor cooling refrigerant into the case 14. The refrigerant supplied into the case 14 cools the rotor 12 and the stator 13 when flowing through the gap G between the rotor 12 and the stator 13 along the flow of the refrigerant in the refrigerant circuit 5. When a clearance S is provided between an inner peripheral part of the case 14 and an outer peripheral part of the stator 13 as with the present embodiment, the clearance S also becomes the flow path of the refrigerant, and the outer peripheral part of the stator 13 is accordingly cooled.

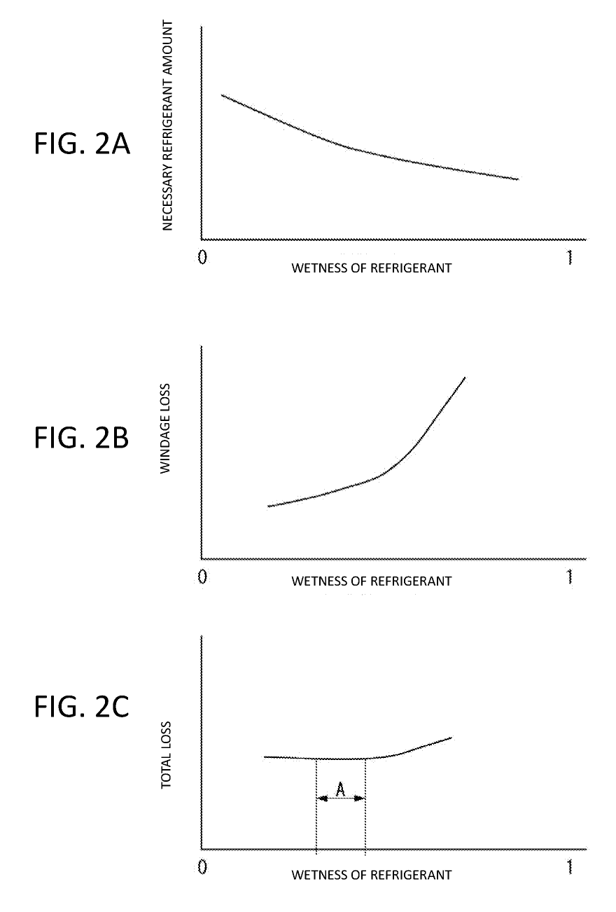

Here, wetness of the refrigerant (the rate of liquid) influences cooling efficiency. A quantity of heat absorbed by latent heat associated with phase transition from liquid phase to gas phase is large as the wetness of the refrigerant at a fixed weight is high. Therefore, as illustrated in FIG. 2A, an amount of refrigerant (weight base) necessary to sufficiently cool the motor 10 is small as the wetness of the refrigerant is high. In other words, an amount of the refrigerant extracted from the refrigerant circuit 5 to cool the motor 10 becomes small as the wetness of the refrigerant is higher.

On the other hand, the wetness of the refrigerant influences windage loss of the motor 10. Frictional resistance is increased as the wetness of the refrigerant (the rate of liquid) flowing through the gap G is higher. Therefore, the windage loss is large as illustrated in FIG. 2B. When the windage loss is large, the necessary amount of the refrigerant is increased.

In addition to the windage loss, it is necessary to consider loss (bleeding loss) that is decrease of a circulation amount of the refrigerant in the refrigerant circuit 5 by the amount of the refrigerant extracted from the refrigerant circuit 5 to cool the motor 10.

Total loss in FIG. 2C indicates total of the windage loss, the bleeding loss, and loss specific to the motor 10 (copper loss and iron loss). The loss specific to the motor 10 does not depend on the wetness of the refrigerant. The windage loss becomes large as the wetness of the refrigerant is higher. In contrast, the bleeding loss becomes small as the wetness of the refrigerant is higher. Note that the total loss illustrated in FIG. 2C is merely an example.

A necessary amount of the refrigerant having appropriate wetness may be preferably supplied to the rotor 12 and the stator 13 such that the total loss reflecting the windage loss and the bleeding loss both depending on the wetness of the refrigerant, becomes small.

To sufficiently cool the motor 10, the motor 10 according to the present embodiment includes: a gas introduction path 20 through which a gas refrigerant is introduced from downstream of the compressor 1 into the upstream chamber R1; a liquid introduction path 21 through which a liquid refrigerant is introduced from downstream of the condenser 2 into the case 14; and a liquid discharge path 23 through which the liquid refrigerant is discharged from the downstream chamber R2 to the refrigerant circuit 5.

In FIG. 1, the gas introduction path 20 is illustrated by a thick dashed line, the liquid introduction path 21 is illustrated by a thick solid line, and the liquid discharge path 23 is illustrated by a thick alternate long and short dash line.

A start end part 20A of the gas introduction path 20 is connected to the middle of the flow path of the refrigerant circuit 5 through which the vapor-phase refrigerant discharged by the compressor 1 flows toward the condenser 2. As a result, a portion of the gas refrigerant discharged by the compressor 1 is distributed into the gas introduction path 20, and is introduced into the case 14 through the gas introduction path 20.

A termination part 20B of the gas introduction path 20 communicates with the upstream chamber R1 through a bottom part 141 (the case 14) of the upstream chamber R1.

A valve 20V is provided in the gas introduction path 20. A flow rate of the gas refrigerant that is introduced into the upstream chamber R1 through the termination part 20B of the gas introduction path 20 is set to a predetermined value by the valve 20V. As the valve 20V, an on-off valve or a flow regulating valve may be used. The valve 20V and a fixed throttle may be used together.

Note that the flow rate of the gas refrigerant introduced into the upstream chamber R1 may be set to the predetermined value through setting of a diameter of the gas introduction path 20 or the like, without the valve 20V.

Opening of the valve 20V may be adjusted depending on pressure condition of the refrigerant circuit 5 and the like.

The above description relating to the valve 20V is also applied to a valve 21V and a valve 22 (in a second embodiment) described later.

The liquid introduction path 21 is arranged from the condenser 2 to the motor 10, and a portion of the liquid refrigerant flowing out from the condenser 2 is distributed from the main stream of the refrigerant circuit 5.

The liquid introduction path 21 is branched, at upstream of the motor 10, into a path (a first path) 211 through which the liquid refrigerant is introduced into the upstream chamber R1, and a path (a second path) 212 through which the liquid refrigerant is introduced into the clearance S between the case 14 and the stator 13.

Each of the path 211 and the path 212 communicates with the case 14 through a top part 142 of the case 14 opposing to the bottom part 141.

The liquid refrigerant introduced into the case 14 through the path 211 and the path 212 moves down by own weight, and forms a liquid reservoir 25 on the bottom part 141 of the case 14. The liquid reservoir 25 is formed at least in the upstream chamber R1 in the case 14. The gas refrigerant spouting from the above-described gas introduction path 20 is introduced into the liquid reservoir 25.

The liquid introduction path 21 includes the valve 21V that sets the flow rate of the liquid refrigerant introduced into the case 14 through the termination part of each of the paths 211 and 212.

In place of the valve 21V, a valve may be provided in each of the paths 211 and 212.

The liquid discharge path 23 is arranged from a bottom part of the lower chamber R2 to the evaporator 4.

Incidentally, main feature of the present embodiment is mixing, in the upstream chamber R1, of the gas refrigerant that is introduced into the case 14 through the gas introduction path 20 and the liquid refrigerant that is introduced into the case 14 through the liquid introduction path 21 and supplying of wet steam of the mixture to at least the gap G of the motor 10. Therefore, the motor 10 is sufficiently cooled by the necessary amount of the refrigerant while suppressing windage loss.

Jet flow of the gas refrigerant introduced into the upper chamber R1 through the bottom part 141 is blown to the liquid refrigerant in the liquid reservoir 25, and blows up the liquid refrigerant along the flow of the refrigerant in the refrigerant circuit 5. As a result, the gas refrigerant is mixed with the liquid refrigerant. In addition, the gas refrigerant is also mixed with the liquid refrigerant that is introduced through the top part 142 of the upstream chamber R1, and drops or runs down along an inner wall of the upstream chamber R1 (the above is mixing step).

A two-phase refrigerant (wet steam) that is a mixture of the gas refrigerant and the liquid refrigerant is supplied to the gap G along the flow of the refrigerant in the refrigerant circuit 5 (supplying step). The wet steam smoothly and sufficiently flows through the gap G, which cools the rotor 12 and the stator 13.

The wet steam of the refrigerant also comes into contact with the coil end 132 that is located in each of the upstream chamber R1 and the downstream chamber R2, and the shaft 11, thereby cooling the coil end 132 and the shaft 11.

In addition, the liquid refrigerant introduced through the path 211 of the liquid introduction path 21 falls on the coil end 132 and the shaft 11, thereby cooling the coil end 132 and the shaft 11.

Further, the liquid refrigerant introduced through the path 212 of the liquid introduction path 21 runs through the clearance S between the outer peripheral part of the stator 13 and the case 14, thereby cooling the stator 13.

As described above, the portion of the liquid refrigerant used for cooling of the motor 10 is gasified and sucked into the compressor 1. An unillustrated partition is provided between the motor 10 and the impeller of the compressor 1 in the upstream chamber R1. Therefore, all the remaining liquid refrigerant that is not gasified are discharged through the liquid discharge path 23 without being sucked into the impeller, and flows into the evaporator 4.

According to the present embodiment, the gas refrigerant introduced into the bottom part 141 in the upstream chamber R1 is blown to the liquid refrigerant collected on the bottom part 141, and the liquid refrigerant is blown up by the gas refrigerant, thereby being mixed with the gas refrigerant in the upstream chamber R1. Further, since the wet steam of the refrigerant is introduced into the gap G, it is possible to sufficiently cool the motor 10 by appropriately setting the flow rate of each of the gas refrigerant to be introduced and the liquid refrigerant to be introduced, for example, through adjustment of openings of respective valves 20V and 21V, and supplying a necessary amount of the refrigerant having wetness that conforms to suppression of windage loss. The flow rate of each of the gas refrigerant to be introduced and the liquid refrigerant to be introduced may be preferably determined so as to achieve an appropriate wetness range A that corresponds to the smallest range of the total loss of the motor 10 including the windage loss and the bleeding loss, as illustrated in FIG. 2C.

### Second Embodiment

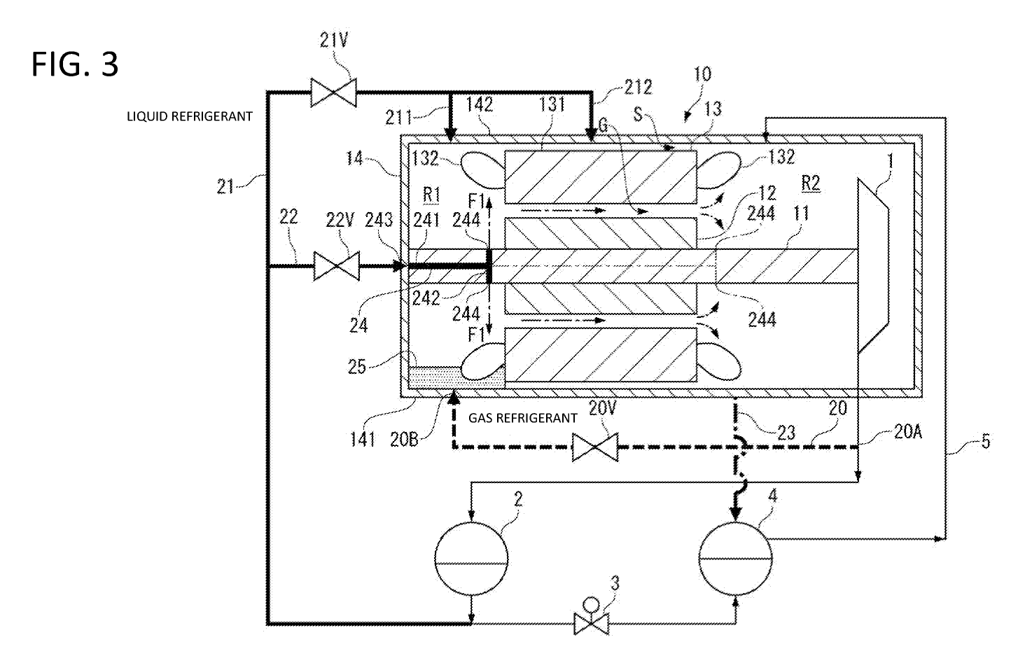

Next, a second embodiment of the present invention is described with reference to FIG. 3.

The matters different from the first embodiment are mainly described below. Components similar to the components of the first embodiment are denoted by the same reference numerals.

The motor 10 according to the second embodiment includes a second liquid introduction path 22, in addition to the liquid introduction path 21 according to the first embodiment. The liquid introduction paths through which the liquid refrigerant is introduced into the case 14 are respectively referred to as the first liquid introduction path 21 and the second liquid introduction path 22.

In the present embodiment, the second liquid introduction path 22 is connected to the first liquid introduction path 21 at the upstream of the valve 21V.

The liquid refrigerant that has flown from the condenser 2 and has been distributed to the first liquid introduction path 21 is further distributed to the second liquid introduction path 22.

A valve 22V is provided in the second liquid introduction path 22. The flow rate of the liquid refrigerant that is introduced into the upstream chamber R1 through a termination part of the second liquid introduction path 22 is set to a predetermined value by the valve 22V.

Note that the second liquid introduction path 22 may be directly connected not to the middle of the first liquid introduction path 21 but to the downstream of the condenser 2.

A flow path 24 that configures a portion of the second liquid introduction path 22 is provided inside the shaft 11.

The flow path 24 includes an axial-direction flow path 241 and a radial-direction flow path 242. The axial-direction flow path 241 extends in the axial center of the shaft 11 along the axial direction. The radial-direction flow path 242 is continuous to the axial-direction flow path 241 and extends along the radial direction of the shaft 11.

The axial-direction flow path 241 includes a receiving port 243 on an end surface of the shaft 11 on the upstream chamber R1 side. The receiving port 243 receives the liquid refrigerant along the axial direction of the shaft 11. A conduit configuring the second liquid introduction path 22 is connected to the receiving port 243.

The radial-direction flow path 242 includes a pair of injection ports 244 on the outer peripheral part of the shaft 11. The pair of injection ports 244 are open to a space inside the upstream chamber R1. Each of the pair of injection ports 244 is open toward the coil end 132 of the stator 13. The injection ports 244 are terminal ends of the second liquid introduction path 22.

The radial-direction flow path 242 according to the present embodiment penetrates the shaft 11 at the terminal end of the axial-direction flow path 241 in the diameter direction.

Centrifugal force caused by rotation of the shaft 11 acts on the liquid refrigerant that is distributed from the downstream of the condenser 2 to the second liquid introduction path 22 and flows through the flow path 24 inside the shaft 11. The centrifugal force acting on the liquid refrigerant that flows through the radial-direction flow path 242 intersecting the axial center of the shaft 11 is larger than the centrifugal force acting on the liquid refrigerant that flows through the axial-direction flow path 241 passing through the axial center of the shaft 11. This provides a centrifugal pumping effect that pumps up the liquid refrigerant from the axial-direction flow path 241 toward the radial-direction flow path 242.

The centrifugal pumping effect causes the liquid refrigerant to be sucked from the downstream of the condenser 2 into the second liquid introduction path 22. Therefore, the liquid refrigerant stably flows through the flow path 24 inside the shaft 11, and is injected from each of the injection ports 244 toward the coil end 132 inside the upstream chamber R1 as illustrated by an alternate long and short dash arrow F1. The coil end 132 is sufficiently cooled by the liquid refrigerant. Since the rotation of the shaft 11 causes the respective positions of the injection ports 244 to rotate, the coil end 132 is cooled over the entire circumference.

Also in the present embodiment, the liquid refrigerant is introduced into the case 14 through the first liquid introduction path 21 and the gas refrigerant is introduced into the upstream chamber R1 through the gas introduction path 20, as with the first embodiment. The gas refrigerant blown to the liquid reservoir 25 in the upstream chamber R1 blows up the liquid refrigerant injected from the injection ports 244, thereby being mixed with the liquid refrigerant. The wet steam of the refrigerant flows into the gap G along the flow of the refrigerant in the refrigerant circuit 5, and flows out from the gap G into the downstream chamber R2. The wet steam of the refrigerant then comes into contact with and cools the coil end 132 located inside the downstream chamber R2.

In the present embodiment, the flow path 24 of the shaft 11 may be extended up to the downstream chamber R2 as illustrated by an alternate long and two short dashes, line in FIG. 3, and the liquid refrigerant may be injected from each of the injection ports 244 toward the coil end 132 located in the downstream chamber R2.

According to the present embodiment, it is possible to directly cool the coil end 132 that remarkably generates heat in the motor 10, by the liquid refrigerant through the second liquid introduction path 22.

In addition, since the liquid refrigerant sufficiently flows through the second liquid introduction path 22 by the centrifugal pumping effect, it is possible to introduce the liquid refrigerant into the case 14 and to mix the liquid refrigerant with the gas refrigerant even when the flow of the liquid refrigerant of the first liquid introduction path 21 is not secured due to pressure condition of the refrigerant circuit 5 or the like.

The centrifugal pumping effect of the second liquid introduction path 22 makes it possible to secure a flow rate of the liquid refrigerant necessary to maintain the motor 10 at allowable temperature or lower.

Accordingly, it is unnecessary to provide an electric pump in the first liquid introduction path 21 for a case where the flow rate of the first liquid introduction path 21 becomes insufficient due to small pressure difference to convey the liquid refrigerant. Elimination of necessity for the electric pump contributes to efficiency improvement of a refrigerator.

Monitoring the pressure condition to circulate the refrigerant in the refrigerant circuit 5 makes it possible to open or close the valve, or to adjust the opening of the valve, depending on the pressure condition. For example, in a case where the pressure difference of the liquid refrigerant flowing through the first liquid introduction path 21 is not secured, the valve 21V is closed and the valve 22V is opened to cause only the second liquid introduction path 22 to effectively function.

In contrast, in a case where the pressure difference of the liquid refrigerant flowing through the first liquid introduction path 21 is secured, desirably, the valve 22V is closed and the valve 21V is opened to cause only the first liquid introduction path 21 to function. This makes it possible to introduce the liquid refrigerant along the circulation of the refrigerant in the refrigerant circuit 5 while eliminating necessity of the input of the motor 10 for pumping up the liquid refrigerant by the centrifugal pumping effect.

The second embodiment including the second liquid introduction path 22 is particularly effective to a case where a low-pressure refrigerant that is hardly leaked and is accordingly easily managed is used. In the case where the low-pressure refrigerant is used, operation pressure necessary for circulation of the refrigerant tends to become insufficient. Therefore, significance of the provided second liquid introduction path 22 is large in such a case.

The term “low-pressure refrigerant” used herein means a refrigerant that has pressure at normal temperature (for example, 20° C.) lower than 0.3 MPa (gage pressure 0.2 MPa with the atmosphere as reference).

As apparent from the first embodiment, in a case where the operation pressure is secured in the second embodiment, only the first liquid introduction path 21 may be used without using the second liquid introduction path 22. In this case, it is sufficient to close the valve 22V and to open the valve 21V. Further, when the operation pressure becomes lower than a predetermined value, the valve 22V is opened, and only the second liquid introduction path 22 or both of the first and second liquid introduction paths 21 and 22 may be used.

In the present embodiment, only the second liquid introduction path 22 may be provided without the first liquid introduction path 21.

### Third Embodiment

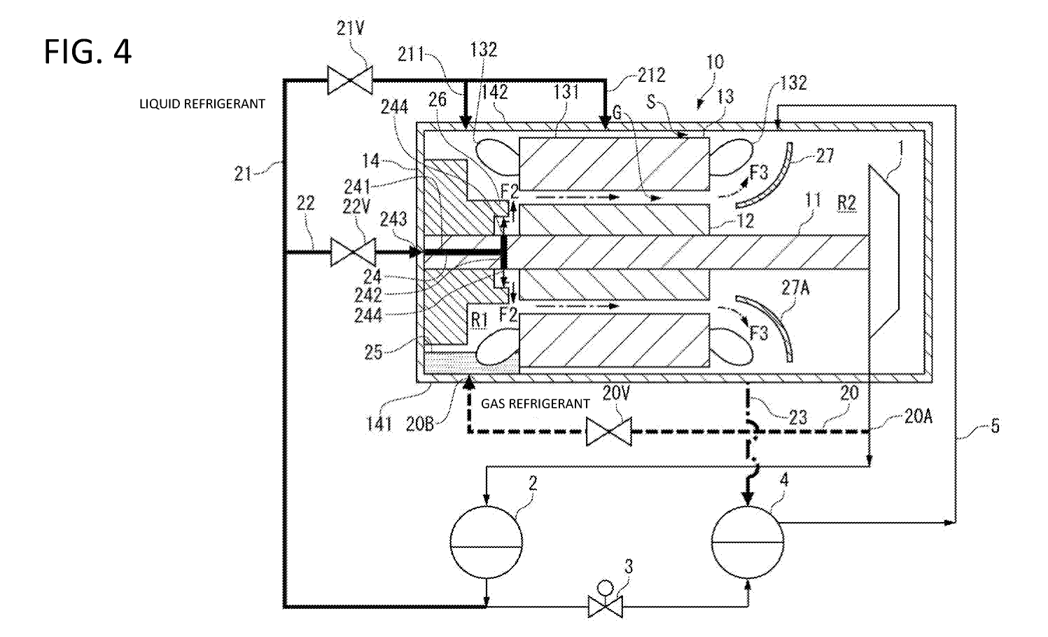

Next, a third embodiment of the present invention is described with reference to FIG. 4.

The motor 10 according to the third embodiment includes a guard portion 26 and a guide portion 27 in the case 14. The guard portion 26 receives once the liquid refrigerant injected toward the coil end 132 located in the upstream chamber R1. The guide portion 27 guides the wet steam of the refrigerant flowing out from the gap G, toward the coil end 132 located in the downstream chamber R2.

The guard portion 26 has an annular shape surrounding the outer peripheral part of the shaft 11 with a distance in between. The guard portion 26 has sufficient strength with respect to injection of the liquid refrigerant. The guard portion 26 may be configured as a portion of the case 14 or a portion of a bearing that rotatably supports the shaft 11.

The guide portion 27 includes a guide surface 27A that is so bent as to be gradually increased in diameter from the vicinity of an opening of the gap G in the downstream chamber R2 toward the front side. The guide surface 27A is continuous in the entire circumferential direction of the shaft 11. The guide portion 27 may be configured as a portion of the case 14 or the like.

In the present embodiment, the liquid refrigerant that is sucked into the flow path 24 inside the shaft 11 and injected from each of the injection ports 244 is received by the guard portion 26, and the liquid refrigerant then passes through the guard portion 26 and reaches the coil end 132 of the upstream chamber R1, as illustrated by an arrow F2. This makes it possible to reduce load that is applied to the coil end 132 by injection of the liquid refrigerant, thereby avoiding damage of the coil end 132.

The liquid refrigerant that has passed through the guard portion 26 is blown up by the gas refrigerant when passing through the vicinity of the opening of the gap G, thereby being introduced into the gap G, as illustrated by an alternate long and short dash arrow F2.

In addition, the wet steam flowing out from the gap G into the downstream chamber R2 is changed in direction toward the coil end 132 by the guide surface 27A of the guide portion 27, as illustrated by an alternate long and short dash arrow F3. Therefore, it is possible to more sufficiently cool the coil end 132 of the downstream chamber R2.

The motor 10 may include any one of the guard portion 26 and the guide portion 27.

In addition, in a case where the flow path 24 of the shaft 11 is extended to the downstream chamber R2 and the liquid refrigerant is injected from each of the injection ports 244 toward the coil end 132 in the downstream chamber R2, the guard portion 26 that receives the injected liquid refrigerant may be preferably provided in the downstream chamber R2.

Other than the above, the configurations described in the above-described embodiments may be selected or may be appropriately modified without departing from the scope of the present invention.

In each of the above-described embodiments, the motor 10 and the compressor 1 are coaxially configured by the same shaft 11; however, the motor 10 and the compressor 1 may separately have a shaft and the shaft of the motor 10 and the shaft of the compressor 1 may be coupled to each other. A gear shifter or the like may be interposed between the shaft of the motor 10 and the shaft of the compressor 1.

In addition, in each of the above-described embodiments, the rotor 12 and the stator 13 of the motor 10 and the compressor 1 are accommodated in the same case 14; however, the compressor 1 may not be accommodated in the case 14.

The direction of the shaft 11 of the motor according to the present invention is not limited, and the shaft 11 may be disposed along, for example, a vertical direction.

The compressor driven by the motor according to the present invention is not limited to the centrifugal compressor, and may be, for example, a scroll compressor or a rotary compressor.

In each of the above-described embodiments, one of the paths 211 and 212 of the liquid introduction portion 21 may be remained and the other path may be eliminated.

Further, the flow path 24 inside the shaft 11 does not necessarily include the axial-direction flow path 241 and the radial-direction flow path, and may be, for example, a hole that is provided obliquely to the axial line of the shaft 11.

The present invention allows the refrigerant to flow, along the flow of the refrigerant in the refrigerating cycle, from a section (R2 in FIG. 1) located on the side on which the compressor 1 is disposed, toward an opposite section (R1 in FIG. 1). Also in this case, it is sufficient to make configuration such that the introduced gas refrigerant and the introduced liquid refrigerant are mixed with each other in a section (R2 in FIG. 1) located on the upstream.

### REFERENCE SIGNS LIST

1 Compressor
2 Condenser
3 Expansion valve (decompression section)
4 Evaporator
5 Refrigerant circuit
10 Compressor driving motor
11 Shaft
12 Rotor
13 Stator
14 Case
20 Gas introduction path (gas introduction portion)
20A Start end part
20B Termination part
20V Valve
21 Liquid introduction path (liquid introduction portion, first liquid introduction portion)
21V Valve
22 Second liquid introduction path (liquid introduction portion, second liquid introduction portion)
22V Valve
23 Liquid discharge path
24 Flow path
25 Liquid reservoir
26 Guard portion
27 Guide portion
27A Guide surface
131 Core
132 Coil end
141 Bottom part
142 Top part
211 First path
212 Second path
241 Axial-direction flow path
242 Radial-direction flow path
243 Receiving port
244 Injection port
A Wetness range
F1 Arrow
F2 Arrow
F3 Arrow
G Gap
R1 Upstream chamber
R2 Downstream chamber
S Clearance

1-10. (canceled)

11. A compressor driving motor driving a compressor, the motor comprising:
a rotor;
a stator that surrounds an outer peripheral part of the rotor;
a case that accommodates the rotor and the stator;
a liquid introduction portion that introduces a liquid refrigerant from a refrigerant circuit into the case, the refrigerant circuit including the compressor; and
a gas introduction portion that introduces a gas refrigerant from the refrigerant circuit into the case, wherein
the case includes a downstream chamber and an upstream chamber, the downstream chamber being located on one end side of the rotor and the stator in an axial direction, and the upstream chamber being located on the other end side in the axial direction and communicating with the downstream chamber through a gap between the outer peripheral part of the rotor and an inner peripheral part of the stator,
the gas introduction portion introduces the gas refrigerant into a liquid reservoir in which the liquid refrigerant is collected, in the upstream chamber,
the liquid refrigerant and the gas refrigerant are mixed with each other in the upstream chamber, and
wet steam of a mixture of the liquid refrigerant and the gas refrigerant is supplied to at least the gap.

12. The compressor driving motor according to claim 11, wherein the liquid introduction portion is branched into a first path through which the liquid refrigerant is introduced into the upstream chamber, and a second path through which the liquid refrigerant is introduced into a clearance between the case and the stator.

13. The compressor driving motor according to claim 11, wherein the liquid introduction portion includes a flow path, and sucks the liquid refrigerant through a pumping effect and injects the sucked liquid refrigerant, the flow path being provided inside a shaft around which the rotor is coupled, and the pumping effect being caused by centrifugal force acting on the liquid refrigerant flowing through the flow path.

14. The compressor driving motor according to claim 13, wherein the liquid introduction portion includes a first liquid introduction portion and a second liquid introduction portion, the first liquid introduction portion introducing the liquid refrigerant into the upstream chamber without through the flow path inside the shaft, and the second liquid introduction portion including the flow path inside the shaft and introducing the liquid refrigerant into the upstream chamber through the injection port.

15. The compressor driving motor according to claim 13, wherein
the case includes a guard portion that receives once the liquid refrigerant injected from the flow path toward a coil end of the stator, and
the liquid refrigerant passes through the guard portion and reaches the coil end.

16. The compressor driving motor according to claim 13, wherein the downstream chamber includes a guide portion that guides, toward a coil end of the stator, the wet steam flowing out from the gap.

17. The compressor driving motor according to claim 11, wherein the compressor is a centrifugal compressor including an impeller.

18. A refrigerant circuit, comprising:
the compressor driving motor according to claim 11;
the compressor;
a condenser;
an evaporator; and
a decompression portion.

19. A cooling method for a compressor driving motor, the motor including a rotor, a stator, and a case, and driving a compressor, the stator surrounding an outer peripheral part of the rotor in a radial direction, the case accommodating the rotor and the stator and including a downstream chamber and an upstream chamber, the downstream chamber being located on one end side of the rotor and the stator in an axial direction and being located on side on which the compressor is disposed, and the upstream chamber being located on the other end side in the axial direction and communicating with the downstream chamber through a gap between the outer peripheral part of the rotor and an inner peripheral part of the stator, the method comprising:
a step of mixing, in the upstream chamber, a liquid refrigerant with a gas refrigerant, the liquid refrigerant being introduced from a refrigerant circuit including the compressor, and the gas refrigerant being introduced from the refrigerant circuit into a liquid reservoir in which the liquid refrigerant is collected, in the upstream chamber; and
a step of supplying, to at least the gap, wet steam of a mixture of the liquid refrigerant and the gas refrigerant.
